(19) United States
(12) Patent Application Publication
(10) Pub. No.: US 2009/0077236 A1
(43) Pub. Date: Mar. 19, 2009

(54) Apparatus and method for managing services received in a local area network

(76) Inventor: Jean-Baptiste Henry, Melesse (FR)

Correspondence Address: Joseph J Laks;Thomason Licensing, P.O.Box 5312, Princeton, NJ, 08543, US

(21) Appl. No.: 11/918,546

(22) PCT Filed: Apr. 11, 2006
(86) PCT No.: PCT/EP2006/061412

§ 371 Date: Oct. 15, 2007

(30) Foreign Application Priority Data
Apr. 8, 2005 (DE) 10 2005 016 510.9

(51) Int. Cl. G06F 15/173; G06F 17/30

(52) U.S. Cl. 709/226; 707/3; 707/E17.001

(57) ABSTRACT

This invention concerns a method for managing access to reception services of resources of a distribution gateway within a local area network. The gateway comprises means for receiving digital services and the capacity to distribute over the local area network to clients the received services. It consists in using levels of priority among the users and modes for booking of the services to manage access conflicts.

### 1. FIELD OF THE INVENTION

This invention relates to the field of digital television and more specifically to its distribution within the house. The broadcasting of digital television services via satellite, cable or even radio channel is now commonplace, the distribution of these very services via a domestic network is at its beginnings. It is advisable to propose solutions enabling distribution of these digital television services on IP networks within the household.

### 2. TECHNOLOGICAL BACKGROUND

The architecture presently under consideration calls upon a broadcasting gateway enabling the reception of broadcast multimedia services and their redistribution within the household via a domestic network. This gateway will have one or more reception modules, called ‘tuners’ in jargon. This may concern cable, satellite, radio or any other reception modules. The broadcasting gateway will be in charge of the distribution of these services on the domestic network. It could do this by using for instance the DVB-IP (Digital Video Broadcasting over IP Infrastructures) standard, documented in “DVB-IP Phase 1 Specifications Handbook” available at the ETSI under the reference ETSI TS 102.034 v1.1.1).

A certain number of clients for these distributed services can be found connected to the domestic network. We can find therein television sets, recording device such as videotape recorders or PVRs (Personal Video Recorders) or others.

The services are generally broadcast batched and multiplexed within data transport streams. These transport streams are organized according to the DVB standard, published by the ETSI (European Telecommunications Standards Institute). This standard is based on MPEG, whose specifications can be found, among others, in the following documents: “MPEG-2 System: ISO/IEC, 1994. Generic Coding of Moving Pictures and Associated Audio: Systems, (MPEG-2 Systems Specification), November, ISO/IEC 13818-1” and “MPEG-2 Video: ISO/IEC, 1994. Generic Coding of Moving Pictures and Associated Audio Video, (MPEG-2 Video Specification), May, ISO/IEC 13818-2”.

Following these standards, the services are therefore batched per multiplex within a transport stream. A reception module could get connected on a transport stream containing a multiplex and extract one or more services from it. Once one of the reception modules will be configured for receiving one of the multiplexes with a view to the distribution of a service contained in this multiplex meant for one of the clients of the domestic network, it will no longer be possible, at least with the help of this reception module, to receive a service belonging to another one of the available multiplexes without interrupting the reception of the ongoing service.

The limited number of reception modules therefore gives rise to constraints as regards the choice of the services at any given moment, among all the available services, offered to a user according to the choices made by the other users of the system.

Other modes of broadcasting of the services can also bring about constraints of a similar nature on the choice of the services. For example, a broadcasting mode on the ADSL line enables to free oneself from the problem of multiplexes (namely each service is theoretically accessible at each moment) but imposes other constraints, typically the bandwidth of the link which allows simultaneous broadcasting of only a certain number of services. For example, a 15 Mbit/s link could support three services at 4 Mbit/s or only one at 14 Mbit/s.

### 3. SUMMARY OF THE INVENTION

The invention aims to define a method for managing the access to the services available within a system comprising clients accessing services broadcast within multiplexes via a limited number of reception modules. The invention also relates to a device managing the reception of the services as per the proposed method.

The invention relates to a method of selection of digital services through a device called client connected to a local area network, the said local area network comprising a device called distribution gateway, the said distribution gateway possessing means of reception of digital services as well as means of distribution on the local area network of the received services, comprising at least the following steps at the client level:
the reception of a list of digital services accessible through the distribution gateway;
the sending of a query requesting the reception of a service from this list;

characterized in that the query comprises a level of priority associated with the query.

According to a specific embodiment of the invention the level of priority associated with the query is a level of priority relating to the user at the origin of the query on the client.

According to a specific embodiment of the invention the level of priority associated with the query is a level of priority relating to the device at the origin of the query on the client.

According to a specific embodiment of the invention, the method comprises furthermore a display step of the list of digital services accessible through the distribution gateway specifying for each service if it can be selected depending on the level of priority relating to the user of the client.

According to a specific embodiment of the invention, the method comprises furthermore a display step of the list of digital services accessible through the distribution gateway specifying for each service if it can be selected depending on the level of priority relating to the client device.

According to a specific embodiment of the invention, the query also comprises a mode of reservation of the means of reception.

According to a specific embodiment of the invention, the mode of reservation comprises a mode in which access to a tuner is exclusive.

According to a specific embodiment of the invention, the mode of reservation comprises a mode in which access to a service is exclusive or a mode in which access to a service is authorized for at least a second client of the services transported on the same transport stream as well as of the service reserved by the client.

The invention also relates to a query service method through a device called distribution gateway connected to a local area network, the said distribution gateway possessing means of reception of digital services as well as means of distribution of the digital services received on the local area network meant for device called clients connected to the local area network comprising at least the following steps:
sending of the list of digital services available;
reception of a query for a digital service comprising a level of priority;
determination of the capacity of the gateway to serve the query;

characterized in that the method comprises furthermore, in case of incapacity of the gateway to serve the query due to the servicing of at least one previous query, a step of choice of the query to be privileged between the query received and the at least one previous query, according to the level of priority comprised in the query.

According to a specific embodiment of the invention, the queries comprise furthermore a level of reservation of the means of reception, the step of choice of the query to be privileged between the query received and the at least one previous query is also made according to this level of reservation.

The invention also relates to a client device connectable to a local area network comprising means of reception of a list of digital services from a distribution device of digital services possessing means of reception of digital services, means of reception of digital services, means of sending a query requesting for the distribution of at least one digital service among the digital services from a list of services received,

characterized in that the means of sending a query requesting for the distribution of at least one digital service among the digital services from a list of services received comprise furthermore means to include a level of priority in the query.

According to a specific embodiment of the invention, the device comprises furthermore means to include in the query a mode of reservation of the means of reception of the distribution device.

The invention also relates to a distribution device of digital services on a local area network comprising means of reception of digital services, means of sending to a client of the local area network a list of digital services accessible by the device, means of reception of a query requesting for the distribution of at least one service among the accessible services,

characterized in that, in case of incapacity of the gateway to serve the query due to the servicing of at least one previous query, the device possesses furthermore means of choice of the query to be to be privileged between the query received and the at least one previous query, according to the level of priority comprised in the query.

### 4. LIST OF DRAWINGS

The invention will be understood better, and other specificities and advantages will appear upon reading of the description which will follow, the description referring to the appended drawings among which:

FIG. 1 represents the overall architecture of an embodiment of the invention in its operating environment.

FIG. 2 represents the hardware architecture of a device according to the embodiment of the invention.

FIG. 3 represents a block diagram of a device according to the embodiment of the invention.

FIG. 4 represents the architecture of the services and the clients in an embodiment of the invention.

### 5. DETAILED DESCRIPTION OF THE INVENTION

In this document, the term broadcasting will be reserved for classic broadcasting of digital services via satellite, satellite, cable or radio channel or others, whereas the term distribution will be reserved to distribution of services on an IP network.

The embodiment of the invention is based on a device, that we name distribution gateway, which makes it possible to receive an initial traditional offer of broadcasting of digital services and making it accessible on a local area network, for instance an IP network. This device is fitted with a reception module called a tuner for receiving a satellite, cable, digital, radio or other type broadcasting. This device is furthermore capable of supplying on the local area network information on the services offered by the broadcasting for bringing the service offer to the notice of the user. When the user chooses a service originating from the broadcasting offer, the distribution gateway transmits on the IP network the broadcast service in the same manner as a distribution server of services on IP. It is obvious for a person skilled in the art that the integration of this functionality can be done at various paces of the local area network and within various device of this network.

The traditional functioning of distribution of services on an IP network involves a service provider who will be distributing these services. Each service will be distributed by one or more servers using a multipoint distribution address. There are several manners in which a service provider can bring its offer to the notice of the users. At the user level, the receiver has to initially take note of the services and the addresses to which they are distributed. He makes a list of these that he can subsequently propose to the user who will select the service that he wishes to receive. The receiver will then send a subscription query to the distribution address used by the service. This subscription query will give rise to the configuration of intermediary routing device between the server and the receivers. The latter will route data packets constituting the stream comprising the service from the server till the receiver. When the user wishes to stop receiving the service, the receiver will send a query for withdrawal of subscription on the address and will stop receiving the packets.

This complete process is generally called discovery and selection of service, or SD&S (for Service Discovery and Selection). There is a standard covering this process called DVB-IP (Digital Video Broadcasting over IP Infrastructures), documented in “DVB-IP Phase 1 Specifications Handbook” available at the ETSI under the reference ETSI TS102.034 v1.1.1).

An embodiment of the invention will now be described. This embodiment is not restrictive and a person skilled in the art will be able to adapt certain aspects thereof without falling outside of the scope of the invention.

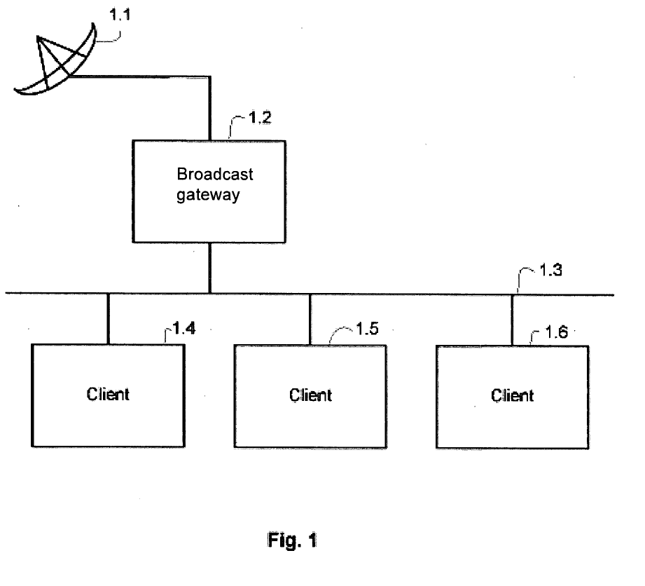

FIG. 1 illustrates the overall architecture of an embodiment of the invention in its operating environment. One can see therein a local area network on IP, referenced as 1.3, connecting on the one hand clients, referenced as 1.4 to 1.6, to a distribution network of services on IP. We call clients, the device making it possible to receive a digital data stream containing a service originating from an IP network. This device is thus the device which will be capable of receiving and decoding the stream on IP. This device will generally be an IP decoder which will be fitted with an IP network and a demultiplexer making it possible to isolate the data packets corresponding to a service, then with a decoder capable of decoding the different elementary streams constituting the service and finally with analog-to-digital converters making it possible to create the analog signals which will be sent to a screen, loud speakers or others for restoring the service. This device can also be a digital television set directly integrating all these functions.

In the embodiment of FIG. 1, the distribution gateway is built like a device in itself, referenced as 1.2, connected on the one hand to the local IP network and possessing a reception module connected to a satellite antenna, referenced as 1.1. This reception module is a satellite module in the embodiment, but could be a cable, radio or other reception module so far as it allows the reception of digital data streams, typically DVB (Digital Video Broadcast).

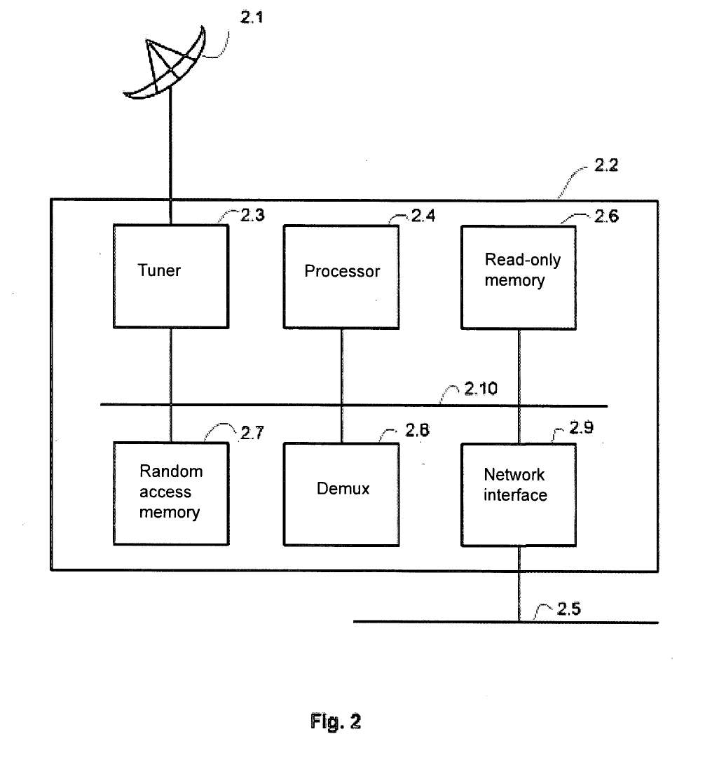

As for FIG. 2, it illustrates the hardware architecture of the distribution gateway, referenced as 2.2, of the embodiment. This gateway is connected to the IP network, referenced as 2.5, via a network interface, referenced as 2.9. It possesses a reception module, referenced as 2.3 and generally called a tuner in the jargon of those skilled in the art. This tuner allows the reception of the signals originating from the satellite and received by the satellite antenna referenced as 2.1. This tuner can be adjusted on a given frequency, receive the signal emitted at this frequency and reconstruct the digital data packets contained in this signal. These packets constituting the received digital data stream is subsequently processed by a packet filter, referenced as 2.8 and generally called demux in the jargon of those skilled in the art. This filter or demux can be programmed for extracting from the stream the packets meeting with certain criteria such as the value of certain fields in the header of the packets. This demux is used, in particular, for extracting a given service from the stream or for selecting the information on the service offer which is contained in the stream. This information on the offer is generally called service information by the person skilled in the art.

These modules interact under the control of software stored in the read-only memory, referenced as 2.6, of the device. These services are loaded in the random access memory, referenced as 2.7, with a view to execution by the processor, referenced as 2.4. The particulars of the main software programs entering into the functioning of the distribution gateway are described hereunder.

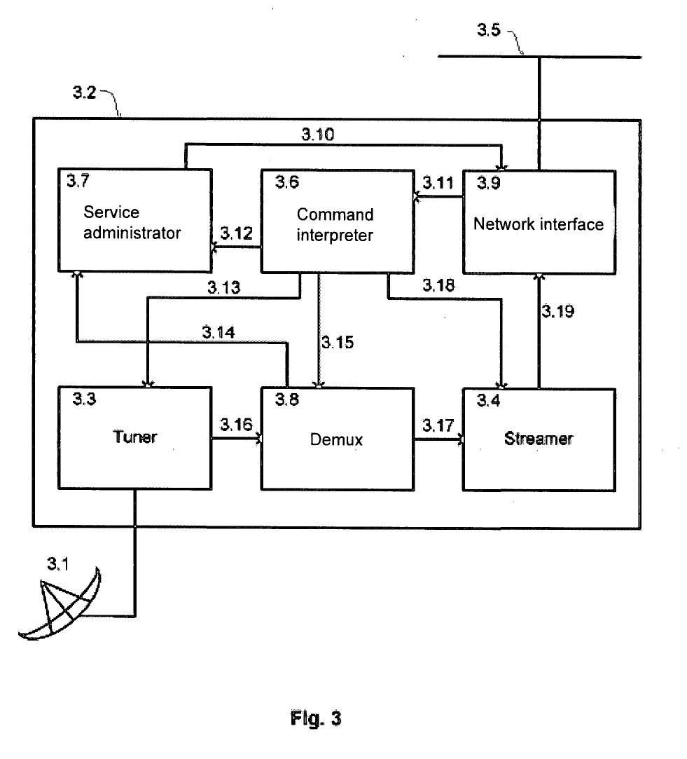

FIG. 3 represents a block diagram of a device according to the embodiment of the invention. We find the gateway, referenced as 3.2, connected to the IP network, referenced as 3.5, and to the satellite antenna referenced as 3.1. We find the modules network interface, referenced as 3.9, tuner, referenced as 3.3 and the demux, referenced as 3.8, seen in their functional aspect. The interactions between the clients of the local area network and the distribution gateway will be managed by a command interpreter, referenced as 3.6. This command interpreter will receive commands or queries from clients via the network interface, which is symbolized by the arrow referenced as 3.11. For the execution of these commands, this interpreter will have to control the tuner, arrow 3.13. It will also have to control the demux, arrow 3.15 and the stream player, referenced as 3.4 arrow 3.18 which will redistribute the previously selected service on the IP network.

Under the direction of the command interpreter 3.6, the tuner will receive a digital data packet stream which will be sent, arrow 3.16, to the demux. The latter will filter, for instance, the packets belonging to a service. These packets are sent to the stream player, arrow 3.17, which is responsible for sending this data packet stream on the IP network. This sending, arrow 3.19, on the IP network can be done, for example, via the RTP protocol (Real Time Transport Protocol) as recommended by the DVB-IP standard. The service administrator, referenced as 3.7, will be responsible for the management of the service information, i.e. information on the accessible service offer. This management will be done under the control of the command interpreter, for instance. The service administrator will receive at the output of the demux, arrow 3.14, the signalling information contained in the stream and will be able to construct the list of available services that it can supply upon query, arrow 3.12, to the requestor client on the IP network, arrow 3.10. The management of the available services has been discussed in greater detail further ahead.

In the embodiment of the invention, the distribution gateway carries out the following tasks at the time of its initialization.

The tuner is started and put in a state wherein it is ready to receive commands. This tuner is a regular tuner such as those that can be found in satellite or cable or radio decoders. It is therefore capable of carrying out the usual tasks of a tuner. Among which we can mention the function of the browsing of a frequency band searching for those used for the broadcasting of a service stream. The function of locking on a given frequency by using a given polarization, a given modulation, and all the current parameters. The tuner will also be capable of supplying the digital data packet stream transmitted on the said frequency.

The list of the services that can be received by the tuner is constructed. We will call this list the list of the DVB services, and a service of this list will be called a DVB service. A broadcasting link is organized in the following manner. The link is generally shared by several broadcasters. Each broadcaster offers a set of digital services for example audio and/or video in the form of a set of services. These sets are broadcast by one or more transport streams. At an initial step, it is commonplace to construct the list of the broadcasters which share the broadcasting link. At a second step the list of the transport streams used is constructed and finally the list of the services contained in these streams can be constructed.

More specifically, in DVB, each broadcaster is identified by a single identifier, the network identifier (network Id) and information about it can be found in a table, the information table on the network or NIT (Network Information Table). This table can be normally found in each transport stream and contains among other things the list of the streams used by each broadcaster.

For each stream, we will find the list of the parameters, such as the frequency, modulation, polarization and other indispensables for the tuner for locking and receiving the stream. We can also find therein the list of the services broadcast in the stream.

For each service, we will find a certain number of information such as the name of the service, an identifier called DVB triplet, the list of the identifiers of elementary audio and video streams (PID for Program Identifier).

Complementary service information can be available in the stream in accordance with the specifications of the DVB-SI standard for Service Information.

All this information therefore makes it possible to construct a list of the available services. This information necessitates knowledge of the broadcast transport streams in order to be able to lock over it and extract the useful information therefrom.

An initial manner of proceeding is to browse the band of the potentially used frequencies in such a manner as to detect those which are used for emitting streams. Each time a stream is detected, the pertinent information is extracted therefrom for constructing the list of the available services. This is a usual function of the tuners. This method is long and monopolizes the tuner which cannot be used in reception of services during this time.

It is also possible to construct the list of the available services according to a configuration file stored in the distribution gateway for instance or elsewhere on the local area network. This file could be in XML format or any other. The XML format has the advantage of being the format retained by the DVB-IP standard for this coding of the service information during distribution of DVB services on IP network. This manner of proceeding is much faster, but presents the risk of obsolescence of the stored information compared with the reality of the broadcast services.

It is also possible to mix both the techniques by storing the list of the services in a file but by authorizing the update of this file through a browsing operation of the frequencies, a regular one or upon request for its updating.

Once the list of the available sources on the broadcasting link has been constructed, this list has to be made available on the local area network. For doing this one possibility consists in using the solution recommended by the DVB-IP standard. This standard proposes to consider the list of the IP services as a collection of objects. Each of these objects possesses, among other things the following information: an identifier which can for example be the DVB triplet, a service name, the service identifiers (PID) of the elementary audio and video streams of the service, the multipoint distribution address to which the service is distributed. This list will be made accessible to the clients via, for instance an HTTP query (Hyper Text Transport Protocol).

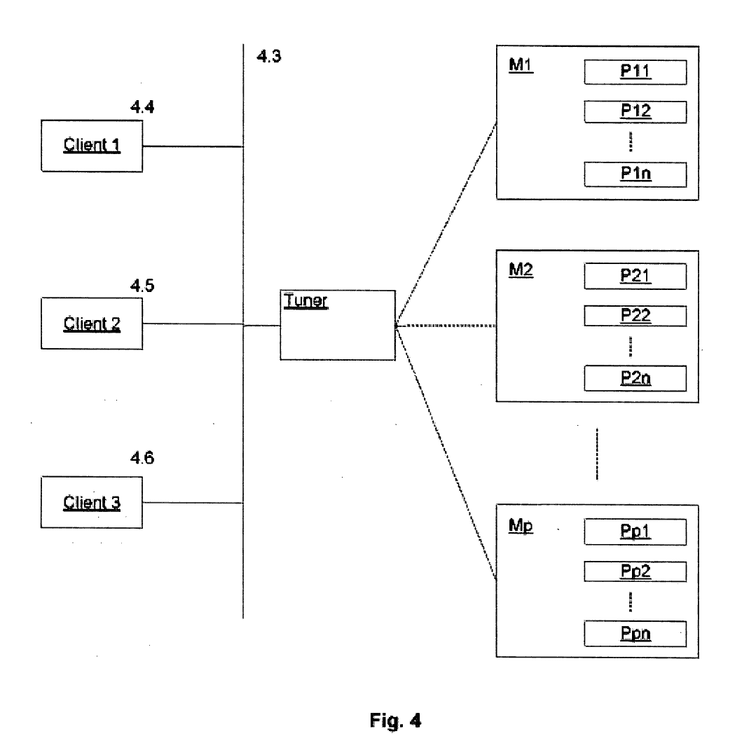

FIG. 4 illustrates the manner in which the services are distributed to the clients. The clients, referenced as 4.4, 4.5 and 4.6, are connected to a local area network referenced as 4.3. A non-represented distribution gateway equipped with a tuner is also connected to this local area network. This tuner makes it possible to receive p transport streams, referenced as M1, M2 and Mp. These are the available p streams. Each one of these streams is distributed, for example, by a satellite transponder on a given frequency. The tuner is capable of locking on a frequency that enables it to receive the transport stream emitted at this frequency. At any given time, the tuner can therefore receive only a single transport stream among the available streams. Each transport stream contains a certain number, let's say n, of services. These services are referenced as Pij, i representing the reference of the transport stream from 1 to P and j the reference of the service within the stream from 1 to n. In the case, not represented, of a gateway containing several tuners, each tuner can lock on its own frequency and receive the corresponding stream. The gateway is therefore capable of receiving the number of transport streams corresponding to the number of tuners that it contains.

The solution allowing the selection of a service will now be described. A specific problem arises here. In fact, the standard presupposes that the services offered are played on the network on a permanent basis. All these services are therefore accessible at all times and this being so in a totally independent manner from one another. Unlike this situation, in the case of the distribution gateway, it is clear that all the available services cannot be played at the same time. This is owing to the fact that, at a given moment, only one transport stream among the available streams can be received by the tuner. It will therefore always be impossible to simultaneously play two services belonging to two different streams unless the distribution gateway is equipped with two or more tuners. However even by equipping the gateway with several tuners, there will always be a restriction as soon as the number of available streams will exceed the number of tuners.

The distribution of a service on IP is done by using the real time transport protocol RTP. Traditionally, when a client wishes to receive an RTP stream distributed in multipoint distribution, he sends a subscription query called ‘join’ on the multipoint distribution address. This query is interpreted by the routing device between the server and the client for distributing the packets emitted by the server to the client. This works well in a context wherein the server plays the service on a permanent basis. In our case wherein the server does plays the service only upon request this mechanism is not sufficient.

For solving this problem, DVB-IP proposes the use of an RTSP query (Real Time Streaming Protocol) enabling to inform a server that one of its services is being requested by a client. This command is known under the command name ‘setup’. The use of this ‘setup’ command is used for allow the distribution gateway to manage the distribution of services. At the same time, a ‘teardown’ command will be sent when a client stops being interested in the reception of a service. These commands comprise a reference enabling the gateway to identify the service concerned by the command.

First of all let us describe the selection of a first service by a first client. The client requests and constructs the list of all the available services. Among all these services it selects one. A ‘setup’ command is sent to the gateway and is interpreted by the command interpreter in order to lock the tuner on the stream containing the requested service. The demux is programmed for filtering the requested service within the stream, this service will therefore be played by the stream player on the network at the distribution address that has been assigned to it. By subscribing to this distribution address the client will therefore be in a position to receive the requested service.

Furthermore, the gateway is duty-bound to know which are the clients that have requested for the reception of a service that it is playing on the network in such a manner as to be able to interrupt the distribution of a service when no client is any longer interested in its reception. One way of doing this is to manage, for each service played, a list of the clients from whom a ‘setup’ command for this service has been received. Therefore upon receipt of a ‘setup’ command and provided that this command can be satisfied, we will see that this is not always the case, the client at the origin of the command is added to the list of the clients requesting the reception of this service. The client will be withdrawn from it when the distribution gateway will receive a ‘teardown’ command from this client relating to this service.

For managing access to the services for the various users of the system within, for instance, a household but the same type of mechanism can be used in a company, it is possible to define levels of priority between the users. For doing this, it is necessary for each user of the system to identify himself. This identification can be done in several ways. For example it is possible, in a family context, to content oneself with offering to the user the choice between several profiles and selecting the relevant profile. In a more sensitive context, wherein we wish to implement parental control, we can demand the user to enter a password, enabling his identification. Of course, many other solutions can be considered in this matter, for example an identification card or recognition of biometric parameters.

The application of this level of priority makes it possible to manage conflicts occurring between the users. In fact, once a user has requested the reception of a service, the tuner is locked on the frequency transmitting the corresponding transport stream. When a second user requests for a second service, several situations may crop up. It can concern the same service, in this case, the second user enjoys the distribution of the service. It can also concern a service transported within the same transport stream as the first service. In this case, a simple programming of the demux makes it possible to extract both the services from the received stream and distribute them on the internal network. A conflict occurs when the second service is broadcast over a transport stream that is different from the first service. In this case the reception of the second service implies locking the tuner on the frequency of the second transport stream. We therefore see that the reception of the second service is exclusive to the reception of the first. It is therefore necessary to choose as to which user is to be privileged. For making this choice we will make use of the levels of priority.

In the case wherein the distribution gateway contains several tuners, the problem is finally the same. It is possible to satisfy all the queries till such time that all the tuners are locked in reception of a transport stream and that a user requests for a service transported within a stream not yet received.

We therefore see that this assignment of a level of priority makes it possible to solve the conflicts. However it can also be useful for allowing the user to specify several levels of reservation when he requests for a service. In fact, it may happen that a user wishes to receive a service in an exclusive manner or that he may even wish to use the resources of the tuner in an exclusive manner.

We can, for instance, consider defining three levels of priority within a household, a highest level priority administrator level for the person in charge of the configuration of the system, a medium level, qualified as ‘parents’, for access to the services by the adults in the household and a low level of priority, qualified as ‘children’, for the children of the household. Quite obviously this example is non restrictive and we can define as many levels of priority as the people in the household or imagine all kinds of policies for the assignment of these levels.

It is also possible to assign the levels of priority according to the client device and no longer the user. This, over and above the fact that it is no longer necessary to have an identification step of the user, makes it possible to privilege certain device as compared to others. It is thus possible to privilege for instance recording device or a main television set in the drawing room as compared to a television set considered as being secondary in the kitchen.

We can also allow the user, at the time of selection of the service, to use several modes of reservation of the means of reception of the gateway.

A first mode, qualified as ‘my-tuner’ mode determines exclusive access of the tuner. In this mode, once the user has got the reception of his service, no other user can use the tuner. In other words no one will be able to receive a service even if it is transported on the same transport stream with the help of the tuner.

A second mode, qualified as ‘my-service’ mode determines exclusive access to the service. In this mode, a second user will be authorized to receive another service transported by the same transport stream but not the first service reserved by the first user.

A third mode, qualified as ‘shared’ mode will authorize the access of a second user to the services transported on the same transport stream as well as to the service reserved by the first user.

A fourth mode, qualified as ‘guest’ mode will be the mode in which the second user can reserve a service transported by a transport stream already received by a first user in ‘my-service’ mode or in ‘shared’ mode.

A fifth mode, qualified as ‘without reservation’ mode will be the mode in which no special reservation is requested for.

This system of reservation, allows the user to subtly indicate the manner in which a user wishes to share the service that he requests for but does not allow avoiding conflicts between users. It is therefore possible to mix the system of priority that has already been described and the system of reservation in such a manner as to settle the conflicts that may occur in this system.

For allowing the construction of a list containing information on the accessible services and the associated reservation status, the tuner should supply the following information:
at the tuner level, its status of reservation
at the service level, its accessibility as well as the mode of reservation of the service.

It is possible to consider that the gateway does not retain the information as to who has reserved what. In this case, it just verifies that the level of reservation and the action of selection is valid for accepting it. It will then be under the scope of the application on the client to manage the priorities and the modes of reservation. This manner of proceeding simplifies the development of the broadcasting gateway.

Moreover, a gateway containing several tuners, will have to distinguish these various tuners and will supply the client with several lists of accessible services. The client will decide if it should or should not unite them at the level of the user interface that it offers. Another possibility is the gateway that manages a single list by uniting the information of each tuner.

It is therefore possible to supply to the user, at all times, an updated list of the available services indicating the accessible status or otherwise of each service. This list can be updated as soon as an action of selection is used by an event management mechanism.

The selection of a programme will give rise to the sending of a command from the client to the gateway containing the identifier of the service, the level of reservation if the reservation mechanism is used as well as the level of priority of the user.

The embodiment of the invention describes the situation of a tuner enabling the reception of a multiplex, but the invention can also be generalized in the case of a module of reception of streams sent over an IP network wherein the limitation will no longer be the frequency of emission of the transport streams but the bandwidth between the broadcasting gateway and the broadcasting servers of the services. Whatsoever may be the technique used for the broadcasting of the services, physical limitations generally restrict the number of services that can be received simultaneously in comparison with the totality of the accessible services. It is therefore possible to apply the invention to all types of broadcasting modes of the services.

Similarly, the levels of priorities as well as the modes of reservation described are such for the purposes of illustration and we can define other policies of application of the levels of priority and other modes of reservation without straying away from the scope of the invention. Similarly, the policy applied for solving a conflict between users having the same priority is free, it is possible to apply a rule of first come first served or on the contrary last arrived first served or any other policy without straying away from the scope of the invention.

The embodiment describes the distribution of the services via an IP network within the household, but it is obvious to the person skilled in the art that the invention works in the same manner whatsoever may be the distribution network of services behind the broadcasting gateway. It may concern a domestic network as per the IEEE 1394 standard or any other type of network enabling to distribute multimedia services.

In fact, the invention can be generalized to all the cases wherein a plurality of users use a resource of access to a plurality of accesses and wherein this resource of access possesses limitations in the number of services that it can simultaneously provide to the users among all the services to which it gives access.

1. Method of selection of digital services through a device called client connected to a local area network, the said local area network comprising a device called distribution gateway, the said distribution gateway possessing means of reception of digital services as well as means of distribution on the local area network of the received services, comprising at least the following steps at the client level:
reception of a list of digital services accessible through the distribution gateway,
sending of a query requesting the reception of a service from this list,
wherein the query comprises a level of priority associated with the query.

2. Method according to claim 1, wherein the level of priority associated with the query is a level of priority relating to the user at the origin of the query on the client.

3. Method according to claim 1, wherein the level of priority associated with the query is a level of priority relating to the device at the origin of the query on the client.

4. Method according to claim 1 comprising furthermore a display step of the list of digital services accessible through the distribution gateway specifying for each service if it can be selected depending on the level of priority relating to the user of the client.

5. Method according to claim 1 comprising furthermore a display step of the list of digital services accessible through the distribution gateway specifying for each service if it can be selected depending on the level of priority relating to the client device.

6. Method according to claim 1, wherein the query also comprises a mode of reservation of the means of reception.

7. Method according to claim 6, wherein the mode of reservation comprises a mode in which access to a tuner is exclusive.

8. Method according to claim 6, wherein the mode of reservation comprises a mode in which access to a service is exclusive.

9. Method according to claim 6, wherein the mode of reservation comprises a mode in which access to a service is authorized for at least a second client of the services transported on the same transport stream as well as of the service reserved by the client.

10. Query service method through a device called distribution gateway connected to a local area network, the said distribution gateway possessing means of reception of digital services as well as means of distribution of the digital services received on the local area network meant for device called clients connected to the local area network comprising at least the following steps:
sending of the list of digital services available;
reception of a query for a digital service comprising a level of priority;
determination of the capacity of the gateway to serve the query;
wherein the method comprises furthermore, in case of incapacity of the gateway to serve the query due to the servicing of at least one previous query, a step of choice of the query to be privileged between the query received and the at least one previous query, according to the level of priority comprised in the query.

11. Method according to claim 10, wherein, the queries comprising furthermore a level of reservation of the means of reception, the step of choice of the query to be privileged between the query received and the at least one previous query is also made according to this level of reservation.

12. Client device connectable to a local area network comprising means of reception of a list of digital services from a distribution device of digital services possessing means of reception of digital services, means of reception of digital services, means of sending a query requesting for the distribution of at least one digital service among the digital services from a list of services received,
wherein the means of sending a query requesting for the distribution of at least one digital service among the digital services from a list of services received comprise furthermore means to include in the query a level of priority.

13. A device according to claim 12, wherein the level of priority relates to the user of the device.

14. A device according to claim 12, wherein the level of priority relates to the device itself.

15. A device according to claim 12 comprising furthermore means to include in the query a mode of reservation of the means of reception of the distribution device.

16. A distribution device of digital services on a local area network comprising means of reception of digital services, means of sending to a client of the local area network a list of digital services accessible by the device, means of reception of a query requesting for the distribution of at least one service among the accessible services,
wherein, in case of incapacity of the gateway to serve the query due to the servicing of at least one previous query, the device possesses furthermore means of choice of the query to be to be privileged between the query received and the at least one previous query, according to the level of priority comprised in the query.

17. A device according to claim 16, the queries comprising furthermore a level of reservation of the means of reception, the means of choice making this choice furthermore according to the mode of reservation contained in the received and previous queries.
